(19) United States
(12) Patent Application Publication
(10) Pub. No.: US 2013/0270483 A1
(43) Pub. Date: Oct. 17, 2013

(54) CATALYTICAL GASIFIER CONFIGURATION FOR BIOMASS PYROLYSIS

(71) Applicants: Moshe BEN-REUVEN, Princeton, NJ (US); Howard L. Fang, Bridgewater, NJ (US); Meifang Qin, Princton, NJ (US); Robert M. Koros, Westfield, NJ (US); Arie Toren, Kendall Park, NJ (US)

(72) Inventors: Moshe BEN-REUVEN, Princeton, NJ (US); Howard L. Fang, Bridgewater, NJ (US); Meifang Qin, Princton, NJ (US); Robert M. Koros, Westfield, NJ (US); Arie Toren, Kendall Park, NJ (US)

(73) Assignee: Primus Green Energy Inc., Hillsborough, NJ (US)

(21) Appl. No.: 13/551,146

(22) Filed: Jul. 17, 2012

Related U.S. Application Data
(60) Provisional application No. 61/623,384, filed on Apr. 12, 2012.

(51) Int. Cl. C01B 3/02; C01B 3/38

(52) U.S. Cl. 252/373; 422/600; 422/139; 422/620; 422/608

(57) ABSTRACT

The invention relates to systems and methods for producing synthesis gas. In particular, the systems of the present invention include two catalytic reactors in series, a wet reformer/gasifier followed by a dry reformer. The systems produce synthesis gas with very little to no methane.

This application claims the priority of U.S. Provisional Patent Application No. 61/623,384, filed Apr. 12, 2012, which is incorporated herein by reference.

### FIELD OF THE INVENTION

The invention relates to systems and methods for producing synthesis gas (syngas). In particular, the systems of the present invention include two catalytic reactors in series, a wet reformer/gasifier followed by a dry reformer.

### BACKGROUND OF THE INVENTION

Pyrolysis, or controlled heating of feedstock in the absence of oxygen, resulting in thermal decomposition of the feedstock fuel into volatile gases and solid carbon material by-product, was first practiced on a commercial scale in 1812, when a city gas company in London started the production of town gas applications. The first commercial gasifier (updraft type) for continuous gasification of solid fuels, representing an air-blown process, was installed in 1839 producing what is known as “producer gas” combustion type gasifiers. They were further developed for different input fuel feedstocks and were in widespread use in specific industrial power and heat applications throughout the late 1800's and into the mid-1920's, when petroleum fueled systems gradually took over the producer gas fuel markets.

In conventional gasification systems, disadvantages often may exist that may create problems in perhaps a variety of areas. Any gasification under reduction condition is accompanied by remaining char and tar formation. The dark brown color tar is a gummy material with a strong odor, possibly caused by partial oxidation products of aldehydes, deposited on char as well as internal pipe surfaces. When water molecules are rapidly removed from cellulosic units, certain ring opening pathways lead to the formation of ethers and dienes which are quickly converted into aldehydes and oxy-acids such as levulinic acid. These oxy-acids are believed to be precursors for tar generation. Besides the tar, significant methane is also formed in the raw syngas after gasification. Effective reduction of tar and CH₄ becomes a necessary step in catalytic gasification.

### SUMMARY OF THE INVENTION

An object of the present invention relates to a system for producing synthesis gas (syngas), preferably for synthetic gasoline synthesis. The system contains two sequential reactors: a first reactor for performing wet reforming and a second rector for performing dry reforming. The first reactor is a gasifier having a first catalyst therein. Gasifiers typically used in the prior art to produce syngas are well-known. Typically, the gasifier takes in biomass and steam, in the presence of oxygen, to produce syngas. The gasifier of the present invention further contains a catalyst to promote further reactions. There are two major functions for the catalyst used in the first reactor: reduction of the char and decomposition of the tar. The catalyst promotes wood interaction with steam that speeds up the char burning. The catalyst decreases the amount of methane (CH₄) in the syngas by converting it to CO and H₂.

The second reactor is a dry reforming reactor containing a second catalyst in the absence of any additional moisture (steam or water). The second reactor takes in the wet syngas from the first reactor and 1) converts any CO₂ in that wet syngas to CO via the reverse water gas shift reaction; and 2) further reduce any CH₄ in that wet syngas to CO and H₂.

Another object of the present invention relates to methods for producing syngas using the system of the present invention. In the process, biomass and steam entered the first reactor to produce wet syngas. The wet syngas is then dry reformed in the second reactor to form the syngas product. The syngas produced (from the exit of the second reactor) preferably contains an H2 to CO ratio of about 1.9 to 2.1, and/or a CH₄ concentration of less than about 4% (by molar fraction). This final syngas product can be used to directly and continuously feed a gasoline synthesis process, such as the one disclosed in U.S. patent application Ser. No. 12/942,680, filed Nov. 9, 2010, which is incorporated herein by reference.

### BRIEF DESCRIPTION OF THE DRAWINGS

FIG. 1 is a schematic of the two reactors of the present invention.

FIG. 2 is a graph showing the temperature dependence of equilibrium constant of the reversed water gas shift reaction (ln K_{eg} vs. T).

FIG. 3 is a graph showing the time response of reactor top pressure.

FIG. 4 is a graph showing the time response of reactor temperatures at the top, middle and bottom, respectively.

FIG. 5 is a graph showing the molar fraction of the gaseous samples collected from the gas exiting of the second reactor (reformer-out).

FIG. 6 is a graph showing the molar fraction of the gaseous samples collected from the gas enterin the second reactor (reformer-in).

FIG. 7 is a graph showing the temperature dependence of equilibrium constant of the reversed water gas shift reaction (K_{eg} vs. T)

FIG. 8 is a schematic of an embodiment of the process of the present invention.

### DETAILED DESCRIPTION OF THE PREFERRED EMBODIMENTS

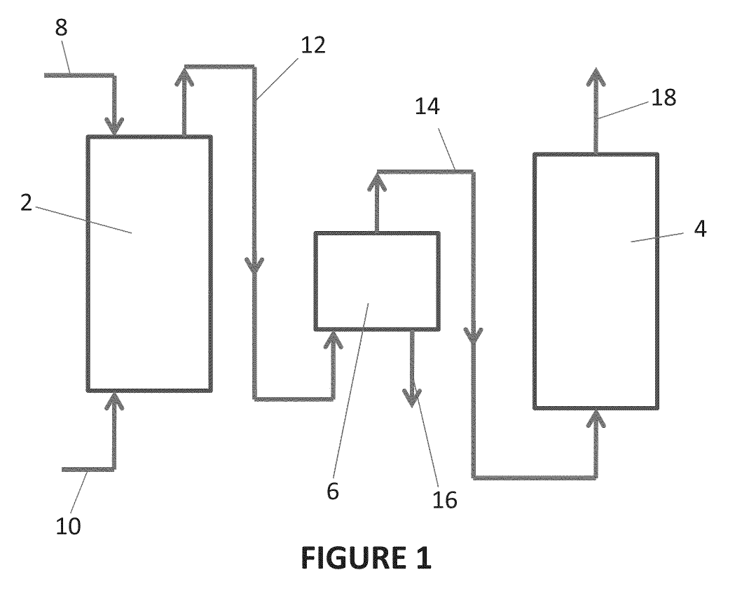

Referring to FIG. 1, which shows the two reactors of the present invention, the present invention relates of a configuration containing a first reactor 1, which is a gasifier having catalyst therein, and a second reactor 2, which is a dry reforming reactor. The first reactor 1 is similar to the common gasifier used to convert biomass to synthesis gas (syngas) using steam. However, the gasifier of the present invention also contains catalysts to promote further reactions. There are two major functions for the catalyst used in gasifier, reduction of the char and decomposition of the tar. The catalyst promotes wood interaction with steam that speeds up the char burning. When the potent catalyst is used in gasifier, the remaining char after the interaction with the steam will decrease from the usual about 17% or higher (without the use of catalyst) to a value of about 5-8%. The removal of tar will also assist the char burning.

Gasifiers for producing syngas from biomass are well-known in the art and all are useful for the present invention. Examples of gasifiers are disclosed in U.S. Patent Application Publication Nos. 2005/0256212, 2005/0032920, 2011/0168947, 2010/0285576, which are incorporated herein by reference. Essentially, the gasifier coverts'biomass, such as wood chips, biosolids, etc., to syngas (mostly CO and H₂) using steam under an oxygen supply less than that needed for complete combustion. As shown in FIG. 1, the biomass enters the first reactor through stream 8; and the steam enters through stream 10. For the present invention, the gasifier also contains a catalyst to convert methane into CO and H₂ by the reaction CH₄+H₂O→CO+3H₂.

Any wet reforming catalyst is appropriate for use in the first reactor (gasifier). The catalyst includes, but is not limited to; No- or Co-based alumina or aluminate. A preferred catalyst in the gasifier is Ni- or Co-dolomite. The most preferred catalyst has a Ni loading of greater than 30%. When Co is used, the Co loading should be 4 or 5 times lower than the Ni loading. Commercially available catalysts include, but are not limited to, HiFUEL® from Alpha Aesar, KL-6515 from Criterion, and NiSAT® from Sud Chemie. Although the soft nature of dolomite lacks resistance towards attrition, the main benefit for the use of Ni-based catalyst is its reforming capability in syngas product where unwanted CH₄ is converted into useful components of CO and H₂. In this case, the unwanted CH₄ is reduced, from about 10% molar fraction (without any catalyst) to about 2-3% with the catalyst. The catalyst in the first reactor 2 can be arranged as a fixed bed, fluidized bed, or semi-fluidized bed, with a fluidized bed being the preferred arrangement.

The first reactor 2 preferably operates at high pressure (10-50 bar), high temperature (600-900° C.) with the flow rate depending on the reactor size and catalyst amount. The preferred range of flow rate is about 1-5 kg/hr per kg catalyst.

The syngas produced in the first reactor is then fed into a second catalytic reactor 4 (also refer to as a dry reformer) in order to further reduce CH₄ by an additional “dry reforming”. The second reactor 4 contains a catalyst, but operates without the addition of water (as steam or liquid). During the dry reforming, part of the CO₂ in the syngas produced in the first reactor is converted back to CO following the reverse water gas shift reaction (rWGS) of CO₂+H₂→H₂O+CO and another fine reforming of CH₄+H₂O→CO+3H₂. The dual reforming scheme is the key in biomass gasification to preserve the carbon source.

In certain embodiments, the wet syngas exiting the first reactor through stream 12 is dried before being fed into the second reactor. The gas in stream 12 contains H₂ (about 30-50%), CO (about 10-25%), CO₂ (about 20-45%), CH₄ (about 2-10%) with the remaining being water. Here, water can be removed from the syngas by various methods known in the art. For example, the wet syngas can be led through a condenser 6 to remove water from the syngas. As depicted in FIG. 1, the water is removed and exited the condenser 6 through stream 16; the rest of the syngas is then fed into the second reactor through stream 14. In a preferred embodiment, two heat exchangers, one gas-on-gas condenser (˜200° C.) and one water-on-gas (˜30° C.) condenser, separate water from the gas phase which contains the syngas. The removal of water favors the rWGS reaction and improves the efficiency of the second reactor.

Any dry reforming catalyst is appropriate for use in the second reactor (dry reformer). The catalyst includes, but is not limited to, Ni- or Fe-based catalysts. The preferred is the Ni-based catalysts. However, the Ni loading of the catalyst used in the dry reformer should be much lower than the Ni loading used in the gasifier. Preferably, the Ni loading of the catalyst used in the dry reformer is less than 15%.

The second reactor 4 can be any common catalytic reactor known in the art. Those reactors can be, but are not limited to, fixed bed, fluidized bed, or semi-fluidized bed reactors. The preferred configuration for the second reactor is a fixed bed reactor. The second reactor 4 preferably operates at conditions depending on the catalyst type and size. Preferably, the second reactor 4 operates at high pressure (10-50 bar), high temperature (600-900° C.), and a flow rate of 1-5 kg/hr per kg catalyst.

After the second reactor 4, the final syngas product, exiting the second reactor 4 through stream 18, contains H₂ (about 40-65%), CO (about 20-35%), CO₂ (about 10-20%), CH₄ (<0.8%) with the remaining being water. Importantly, the final syngas product contains essentially no methane (<8%), a drop from about 2-10% (exiting the first reactor). In the final syngas product, the ratio of H₂/CO is about 1.9-2.1% in the composition, which is adequate for making synthetic fuel, for example, by the synthesis process disclosed in U.S. patent application Ser. No. 12/942,680, filed Nov. 9, 2010, which is incorporated herein by reference and referred to hereafter as the MTGH process. The accumulation of CH₄ becomes a diluent in MTGH operation that not only lowers the fuel yield but also generates tendency for carbon formation. The reduction of CH₄ is the obvious merit in the present dual reactor system to make syngas. Another benefit is its potential as an on-line reformer which can be directly connected to the MTGH process to generate fuel in a continuation operation. For the case of excessive CO₂, an on-line scrubber to remove CO₂ may be needed prior to feeding the syngas into the MTGH process. However, the presence of CO₂ is less detrimental than CH₄.

Upon exiting the second reactor 4, the syngas product may be scrubbed to to remove CO₂. That is especially advantageous when the CO₂ content is greater than about 7%. Any CO2 scrubbing process known in the art can be used, for example, water scrubbing, amine scrubbing, pressure swing adsorption (PSA), or temperature swing adsorption (TSA).

In an embodiment, at least part of the CO₂ exiting the second reactor is recycled to the first reactor. This CO₂ is preferably fed to the first reactor in pulses. The pulsed injection of CO₂ serves two purposes: 1) to assist the injection of biomass into the first reactor; and 2) to drive the rWGS reaction (CO₂+H₂→CO+H₂O). The CO₂ is preferably pressurized to push the biomass into the first reaction.

Without further description, it is believed that one of ordinary skill in the art can, using the preceding description and the following illustrative examples, make and utilize the compounds of the present invention and practice the claimed methods. The following examples are given to illustrate the present invention. It should be understood that the invention is not to be limited to the specific conditions or details described in those examples.

### Example 1

### Gasifier Containing Catalyst

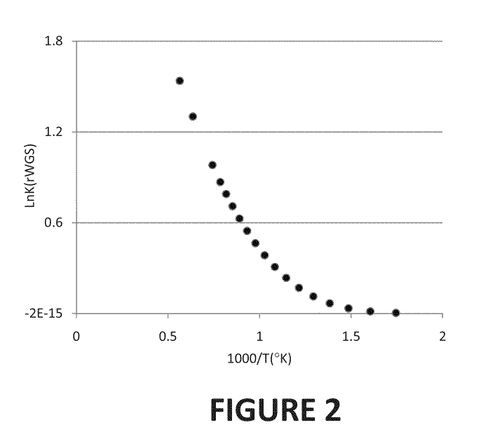

A pilot unit consisted of a catalytic fluidized bed gasifier (6″) and a 10″ fixed bed dry reformer separated by water condenser and separator. The catalyst used in the gasifier (first reactor) was in pellet shape with rough granulation which allowed operation at relatively high fluidization speeds, needed for effective pellet gasification. The injection of wood pellet was assisted by CO₂ pulses. The use of CO₂ as the pulsation gas was a unique feature in our current configuration which was quite different from the inert gas, such as N₂ or Argon, commonly used in conventional gasifiers. Since the inert gases did not participate the reforming chemistry, they simply behaved as diluents in the syngas and reduced the overall conversion efficiency. In addition, the water gas shift reaction (WGS) (CO+H₂O→CO₂>+H₂) was commonly exercised in conventional gasifiers to increase the H₂/CO ratio. The high H₂/CO ratio was achieved by a sacrifice of CO content in the denominator by a conversion of CO into CO₂ caused by the WGS. This was the reason that high conversion efficiency did not exist for conventional gasifiers. In our current configuration, the CO₂ was purposely injected in not only as the pulsation gas to assist the wood feeding, but also as the reactant for the reversed water gas shift reaction (rWGS, CO₂+H₂→CO+H₂O). Based on the temperature dependence of the equilibrium constant for the rWGS (K_{eq}(rWGS)=[CO][H₂O]/([CO₂][H₂]) (FIG. 2)), a reasonable value was observed under common temperature condition for gasification (about 750-950° C.).

Basically, the catalyst in the gasifier (first reactor) promoted the gasification process of wood pellets and provided a significant improvement in H₂ generation through steam reforming. Part of the excess H₂ was then used in the dry reformer (second reactor) through the reversed water gas shift reaction to preserve some CO which is the carbon source in the generated syngas. The avoidance of CO depletion was the key for our reactor design for producing syngas.

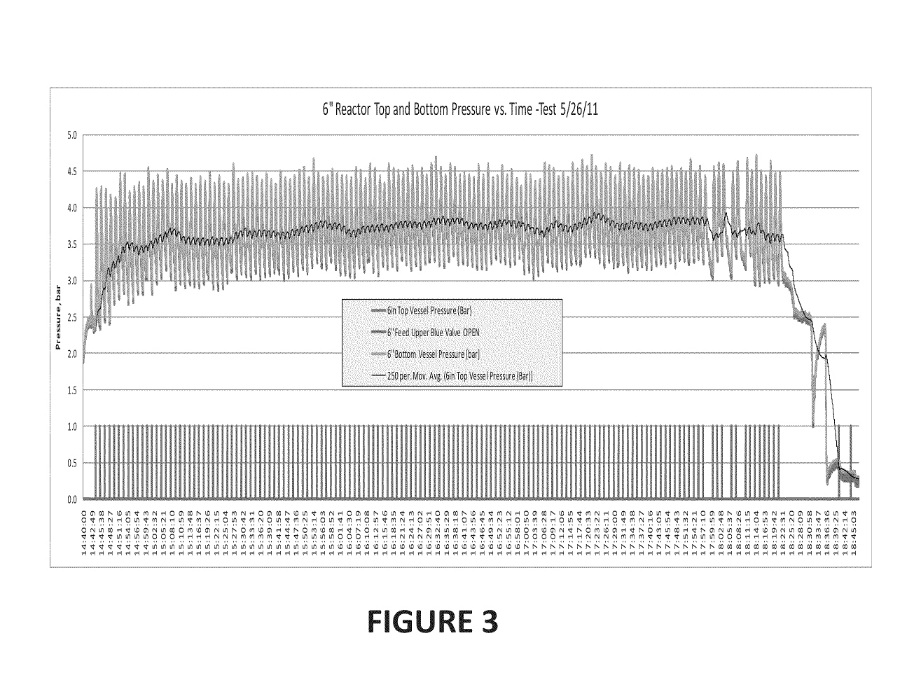

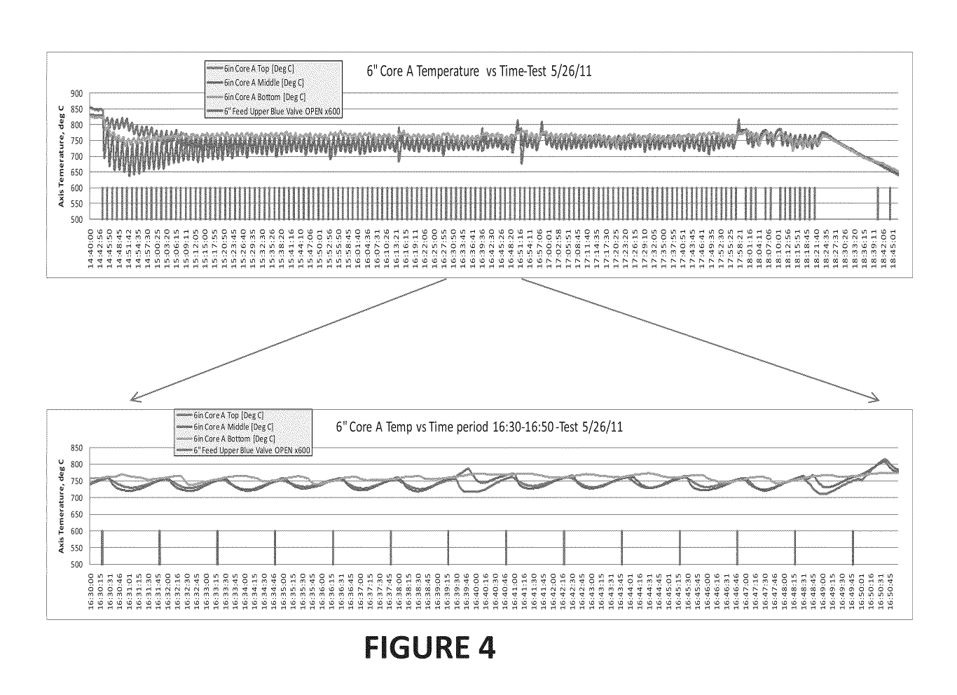

Another interesting observation in gasification experiment was the pulse feeding of the wood pellet doesn't generate much perturbation in the overall pressure profile of the reactor. The time dependence of the reactor pressure is shown in the Labview curve of FIG. 3. Although each pulse lasts 90 seconds with an amplitude of 1.5 bar (22 psi), the overall pressure (depicted as the black color as the average curve) of the gasifier was almost a constant around 3.5 bar (51 psi). That implied that the system could easily reach a steady condition with little pressure fluctuation. It was also noted that the average reactor pressure can be adjusted to higher value depending upon the gasifier design. The temperature response si also shown in FIG. 4 where several thermal couples marked top, middle and bottom are used to monitor the local temperature readings within the reactor. The fluctuations of all temperature readings were in relatively small ranges (about 3-4.5° C.).

### Example 2

### Dry Reformer

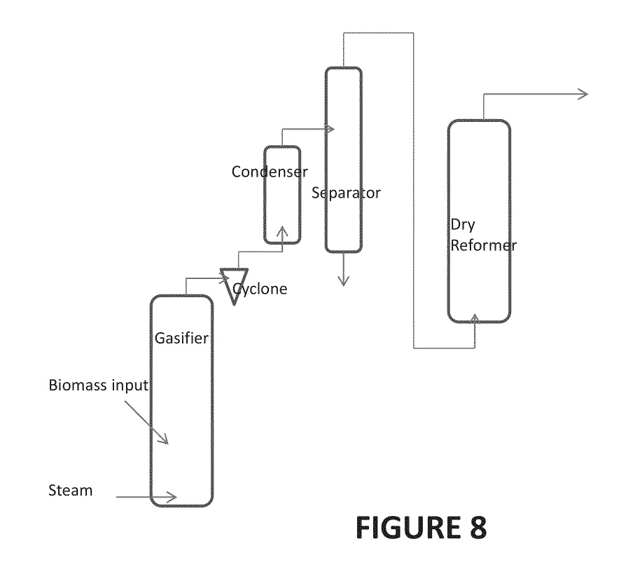

The wet syngas produced from the gasifier (first reactor) was fed through a series of cyclones designed to sort out small char particles, mixed with some catalyst debris. The powdery material was periodically collected to analyze the char content. The catalyst was regenerated through a regeneration scheme, e.g. by hot hydrogen stripping, in order to remove the unnecessary buildup of carbonaceous materials. The gasifier and the dry reformer were separated by two heat exchangers, one gas-on-gas condenser (˜200° C.) and one water-on-gas (˜30° C.) condenser, before connecting to a water separator. After the removal of water, an effective dry reforming was conducted in the dry reformer (second reactor). The preferred configuration used is as shown in FIG. 8.

It was interesting to compare the difference of moisture contents between the top of gas-on-gas and the top of H₂O-on-gas exchangers. The difference was related to the temperature difference. The analytical data are listed in Table 1. Due to the wet cold head, the catalyst powder also landed in this area. This was the reason that the remaining catalyst ash turned out to be high at the top of the H₂O-on-gas exchanger. Significant amount of catalyst powder was collected in the cyclone area. Because high temperature burning of carbonaceous materials also oxidized the Ni-catalyst into NiO, the catalyst weight needed to be corrected by 0.78 (Ni/NiO). Based on our previous trial, the loss rate of the catalyst was about 0.5 Kg/hr. Based on the time response of the steam flow, the formation of huge chunk of char inside the gasifier was caused by extremely low steam rate. When steam rate is low, the gasification of wood simply cannot function.

TABLE 1

| | [Moisture] % | [C] % | [Catalyst] % |
|---|---|---|---|
| Morphology and location | Wt loss at | burnable wt | remaining wt |
| of the deposit | 110° C. | at 650° C. | at 650° C. |
| Cyclone C | 31.5% | 40.9% | 27.6% |
| Gray color, soft wet form | | | |
| Top deposit at gas-on-gas | 16% | 75.3% | 8.7% |
| exchanger Black color, | | | |
| char-like hard particles | | | |
| Top deposit at H2O-on-gas | 35% | 42.7% | 22.3% |
| exchanger Dark wet paste | | | |

The binding mechanism of tar with metal and carbonaceous surface might be caused by hydrogen bonding and carboxylate formation. The surface hydroxyl groups (—OH's) on metal and soot surfaces could interact with the acid functionalities of the tar to form hydrogen bonding interaction or neutralization products of carboxylates where the metal oxides, coming from either the metal surface or the wood ash, served as cation counterparts. Formula I illustrates the chemical interactions.

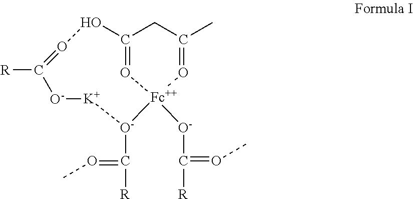

In other words, surface hydroxyl groups with high tendency to form carboxylic (ester) linkages served as interconnected binding bridges suitable for aggregation growth of tar. All soot particles, as well as debris from both metal and catalyst, could be glued by the tar to form aggregate mixture with a large size.

When tar molecules are small, they are reasonably soluble in warm water or other polar solvents, such as acetone. Due to the fast size growth, the large aggregate of tar with high molecular weight begins to show relatively low solubility in water or acetone. The main function of the catalyst used in the gasifier (first reactor) was to “rapidly” decompose the tar to avoid the formation of large aggregation formation. The timing to minimize the residence time of tar within the first reactor turned out to be one important controlling factor. If the tar decomposition rate was not fast enough (such as the non-catalyst condition) or the gasification process is not effective (such as the use of low pressure or inappropriate steam amount), the remaining tar would quickly extend its binding power to mix with soot and other debris to form large chunks of char cake. When the growth of char cake is excessive, flow plugging results.

In order to reach a syngas with ultra-low CH₄, our gasification system contained a combination of a steam reforming unit (first reactor), followed by a dry reforming unit (second reactor) in a sequential series. Although some of CO₂ was used in the control valves that pushed the wood pellets into the gasifier (first reactor), no additional CO₂ was fed into the system to reverse the water gas shift reaction of CO+H₂O→CO₂+H₂. A high Ni-loading catalyst (>30% Ni loading) was used in gasifier (first reactor) under a pseudo-fludized bed mode to assist the wood interaction with the steam to generate sufficient H₂ and CO. The catalyst assisted steam reforming by the reaction CH₄+H₂O→CO+3H₂. A relatively low Ni-loading catalyst (<15% Ni loading) was used in the dry reformer (second reactor) under a fixed bed mode to carry out the dry reforming. The aged catalysts can be regenerated by methods known in the art (e.g. hot hydrogen stripping). The lifetime of the catalyst used in the fluidized bed appeared shorter than the one used in the fixed bed.

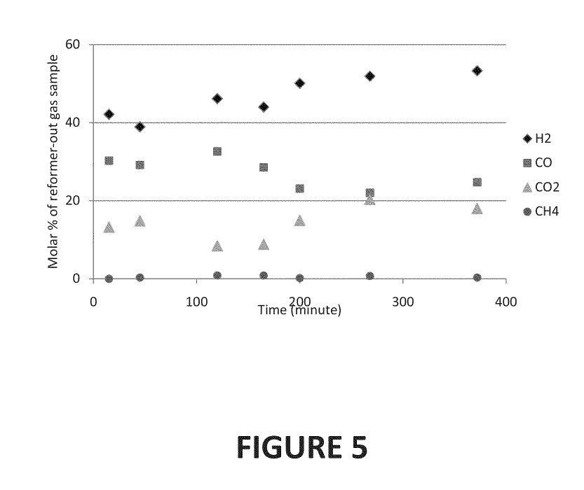

The performance of the two reactors can be seen by the gaseous GC data coming out of the reformer as shown in FIG. 5. During almost 6-hour period of operation, the H₂ was maintained high (about 40-60%) and the CO was maintained at a desirable value (about 20-30%), so that the ratio of H₂/CO was close to 2 which is ideal for MTGH process. Most importantly, the CH₄ was always low (<0.8%), suggesting that the dry reforming process in the second reactor was functioning as designed.

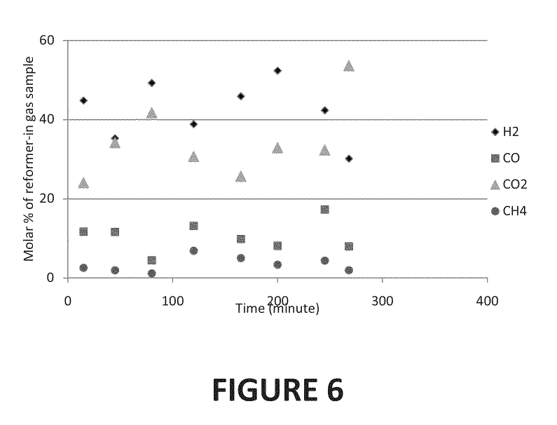

It was also interesting to compare the reformer-out (final syngas product produced in the second reactor) data to the corresponding value of the reformer-in (the syngas entering the second reactor), which is depicted in FIG. 6. The CO₂ in the reformer-in was much higher than in the reformer-out; and the CO in the reformer-in followed an opposite trend to the one for the reformer-out. It was clear that the rWGS reaction was occurring within the dry reformer (second reactor), CO₂+H₂→CO+H₂O. In addition, the CH₄ content in the reformer-in (2-4%) was always larger than the one observed for the reformer-out, suggesting that the steam reformer (first reactor) really needed another level of CH₄ reduction through dry reforming to produce syngas appropriate for the MTGH process.

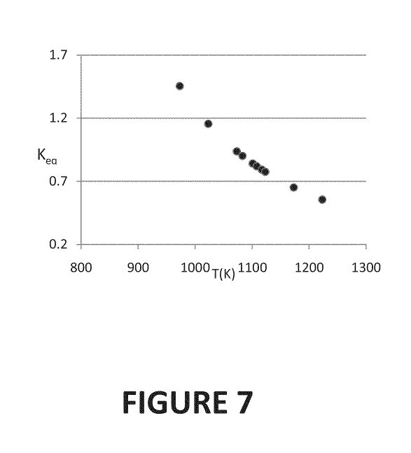

Another important observation was that the equilibrium constant of the WGS reaction of CO+H₂O→CO₂+H₂ (K_{eq}(WGS)=([CO₂][H₂])/([H₂O][CO])) turned out to be sensitive to sampling location. The K_{eq} for reformer-in samples were normally large (>1), while the K_{eq} for reformer-out samples are close to 1. The large value of K_{eq} suggested that the reaction was favored toward right (the WGS reaction), while the small K_{eq} suggested that the reaction favored to the left (the rWGS reaction). The temperature dependence of the K_{eq} is shown in FIG. 7, where K_{eq}=1 is in the vicinity of 1030° K. This diagram is similar to FIG. 1 in a reversed order.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. A system for converting biomass to synthesis gas comprising a first reactor which is a gasifier having a first catalyst therein for converting CH₄ to CO by steam reforming; a second reactor, fluidly connected to the first reactor, having a second catalyst therein for converting CH₄ to CO and CO₂ to CO by dry reforming, and a condenser located between the first and second reactors for removing water from gas produced in the first reactor before feeding that gas to the second reactor, such that the gas fed into the second reactor contains less than about 10% water.

2. The system of claim 1, wherein the first reactor is configured as a fluidized bed.

3. The system of claim 1, wherein the second reactor is configured as a fixed bed.

4. The system of claim 1, wherein a H2 to CO ratio in the synthesis gas produced in the second reactor is about 1.9 to 2.1.

5. The system of claim 1, wherein the CH4 concentration in the synthesis gas produced in the second reactor is less than about 4%.

6. The system of claim 1, wherein the first catalyst contains more than 30% Ni or Co loading.

7. The system of claim 1, wherein the second catalyst contains less than 15% Ni.

8. The system of claim 1, wherein the CO₂ exiting the second reactor is recycled to the first reactor.

9. The system of claim 1, wherein the second catalyst catalyzes the following reactions:
CO₂+H₂->H₂O+CO
CH₄+H₂O->CO+3H₂.

10. The system of claim 1, wherein the first catalyst catalyzes the following reaction:
CH₄+H₂O->CO+3H₂.

11. (canceled)

12. (canceled)

13. A method for converting biomass to synthesis gas comprising the steps of
a. feeding biomass into a first reaction containing steam and a first catalyst for converting CH₄ to CO; and
b. feeding the gas produced in the first reactor into a second reactor containing a second catalyst for converting CH₄ to CO and CO, to CO.

14. The method of claim 13, wherein the first reactor is configured as a fluidized bed.

15. The method of claim 13, wherein the second reactor is configured as a fixed bed.

16. The method of claim 13, wherein the H2 to CO ratio in the synthesis gas produced in the second reactor is about 1.9 to 2.1.

17. The method of claim 13, wherein the CH4 concentration in the synthesis gas produced in the second reactor is less than about 4%.

18. The method of claim 13, wherein the first catalyst contains more than 30% Ni or Co loading.

19. The method of claim 13, wherein the second catalyst contains less than 15% Ni or Co loading.

20. The method of claim 13, wherein the CO₂ exiting the second reactor is recycled to the first reactor in pulses.

21. The method of claim 13, further comprising a step of removing water from the gas produced in the first reactor before feeding it into the second reactor.
